(19) United States
(12) Patent Application Publication
(10) Pub. No.: US 2012/0088058 A1
(43) Pub. Date: Apr. 12, 2012

(54) AQUEOUS SOLUTION-ABSORBING MAT

(76) Inventor: Charles Rick, Floral Park, NY (US)

(21) Appl. No.: 13/083,863

(22) Filed: Apr. 11, 2011

Related U.S. Application Data
(60) Provisional application No. 61/322,385, filed on Apr. 9, 2010.

(51) Int. Cl. B32B 5/28

(52) U.S. Cl. 428/76

(57) ABSTRACT

A mat for absorbing aqueous solutions has a bottom sheet with a liquid-impervious layer, an top fabric layer overlying the bottom sheet and providing a top surface for the mat, and a superabsorbent polymer located between the bottom sheet and top fabric layer. The bottom sheet is joined to the fabric layer about their mutual peripheries, the polymer being thereby retained between the bottom sheet and fabric layer. The polymer may be supported by a fabric matrix captured between the bottom sheet and the fabric layers.

This application claims the benefit of Provisional Application 61/322,385 filed Apr. 9, 2010.

The present invention relates to the mechanical arts, and in particular to a mat construction adapted to absorb liquids, such as water, and thus prevent damage to surfaces which may otherwise be exposed to such liquids, such as by overflow, drippage, and the like.

### BACKGROUND OF THE INVENTION

Particularly around the home, protection against inadvertent spillage of water and other liquids is of significant interest. House plants, for example, are prone to over-watering, whereby the excess water either escapes from the flowerpot through a bottom weep hole, or overflows over the side of the pot as watering occurs. Even when the pot is placed in a saucer to retain the overflow, the excess water may exceed the capacity of the saucer.

Other household situations likewise may generate excess or unwanted liquids. Such may appear, for example, from a leaking refrigerator water dispenser, or may appear as seepage through a pet litter box. A leaky pipe or condensation on a water closet surface may likewise cause unwanted drippage.

### BRIEF DESCRIPTION OF THE INVENTION

The present invention combats these situations, by providing a highly absorbent fabric mat capable of retaining a relatively large volume of water relative to its size and thickness. The mat is backed by a liquid-impervious sheet that further prevents the absorbed liquid from reaching the surface on which the mat construction is placed. The mat includes a layer having a superabsorbent polymer, which converts the liquid to a gel that remains trapped in the mat.

### DESCRIPTION OF THE DRAWING

FIG. 1. is a diagrammatic exploded view of a mat of the present invention.

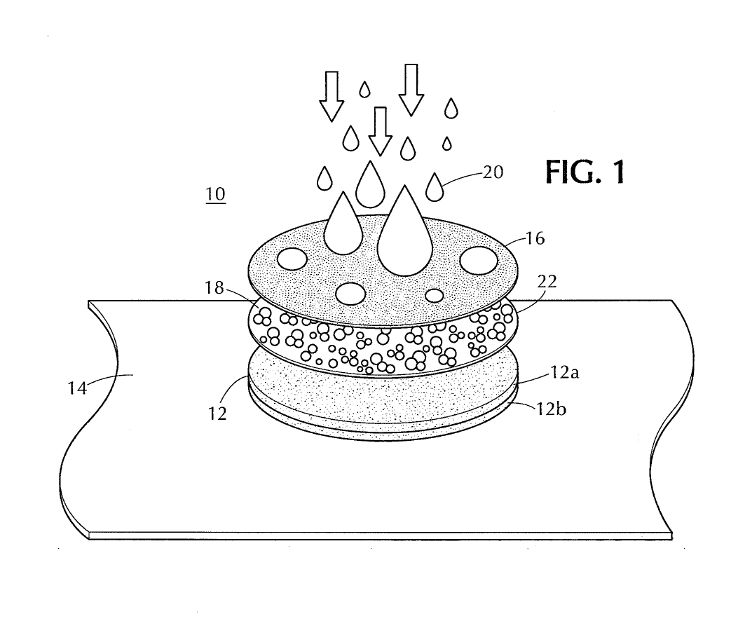

### DETAILED DESCRIPTION OF THE INVENTION

As illustrated in the FIGURE, a mat construction 10 of the invention includes a protective bottom sheet 12, which may be constructed of a thin plastic element or other liquid-impervious material. It serves a base for the mat, and prevents the fluid being absorbed from reaching the surface 14 upon which the mat is placed, such as a floor, as it is being absorbed as well as preventing contact between the liquid-absorbed gel and the floor. The sheet 12 may itself be a composite, with a lower layer 12b of a non-slip material and upper layer 12a of the liquid-impervious material.

Top fabric layer 16 overlies the sheet 12. The fabric may itself be chosen from a variety of materials, such as cotton or a synthetic fabric. While the fabric may have absorbent properties to assist in the retention of the liquids 20, it is preferably treated to be hydrophilic, as known in the art, to maintain a dry surface upon which the object placed on the mat sits. The sheet may have a texture appropriate to the specific use of the mat. For example, if a flowerpot is to be placed on the mat, the fabric may have a ridged upper surface to prevent the flowerpot from sliding. The primary function of the fabric, however, is to allow passage of the liquid 20 to the primary absorbent 18 while providing an attractive appearance.

The primary absorbent, in the form of a superabsorbent polymer (SAP) 18, is located between the bottom sheet 12 and the upper fabric layer 16. The SAP is a hydrogel that is capable of absorbing aqueous solutions through hydrogen bonding. The SAP may be a poly-acrylic acid sodium salt, as known in the art, which is formed into granules. While the SAP may simply be placed on the surface of the bottom sheet 12, it is preferably is supported in a manner such that it is evenly dispersed across the area of the mat. This may be achieved, for example, by suspending the granules in a fabric matrix 22 positioned between the bottom sheet and the upper fabric layer. The granules may be placed into solution, as known in the art, and the fabric matrix is then saturated with the solution and allowed to dry. Alternatively, the SAP granules may be simply embedded within the fabric matrix. In a currently preferred embodiment the granules may be sandwiched between two thin fabric sheets, such as tissue paper. The granules may be further gently adhered in place across the sheets by a mild adhesive, such as a corn-based glue as known in the art. The glue can also be used to adhere the two sheets together.

The upper layer 16 is bonded to the bottom sheet around their common peripheral edges, such as by gluing or, depending on the nature of the materials employed, through heat melt welding. When employed, the fabric matrix 22 is preferably of a smaller area, whereby it is simply retained between the upper and lower layers, but not bonded to either. If the granules are not contained within a matrix, they may be simply spread upon the bottom layer before the upper layer is mated thereto and bonded. Alternatively, all three layers, 16, 22 and 12, may be bonded together, using the same type of adhesive used to join the layers of the fabric matrix 22. When so bonded, however, the peripheral sealing bond is still employed to prevent leakage.

Dried SAP has the capability of absorbing or converting to a gel on the order of 30 to 60 times its own volume of distilled water, with lower volumes depending on the nature of the aqueous solution into which it comes in contact.

The shape of the bottom sheet 12 and fabric 16 may be of any shape desired, consistent with the amount of SAP to be utilized and the esthetic effects desired, although circular forms may be preferred. When the mat has reached its saturation point, it can be dried to return the SAP to a granular form, whereby the mat can be reused.

I claim:

1. A mat for absorbing aqueous solutions, comprising a bottom sheet having a liquid-impervious layer, an absorbent fabric layer overlying the bottom sheet, and a superabsorbent polymer located between the bottom sheet and absorbent fabric layer, the bottom sheet being joined to the fabric layer about mutual peripheries thereof, the polymer being thereby retained between the bottom sheet and fabric layer.

2. The mat of claim 1, wherein the superabsorbent polymer is suspended in a fabric matrix.

3. The mat of claim 2, wherein the polymer is embedded in the matrix through a mechanical process.

4. The mat of claim 2, wherein the polymer is embedded in the matrix by saturating the matrix in a dissolved polymer solution and allowing the solution to dry.

5. The mat of claim 3 wherein the polymer is in the form of granules between upper and lower fabric sheets forming the matrix.

6. The mat of claim 5 wherein the polymer is adhered to at least one of the upper and lower fabric sheets.

7. The mat of claim 6 wherein the upper and lower fabric sheets are adhered together.
